(19) United States
(12) Patent Application Publication
(10) Pub. No.: US 2026/0018074 A1
(43) Pub. Date: Jan. 15, 2026

(54) ASYNCHRONOUS ORAL ASSESSMENT

(71) Applicant: Boise State University, Boise, ID (US)

(72) Inventor: Steven Pentland, Boise, ID (US)

(73) Assignee: Boise State University, Boise, ID (US)

(21) Appl. No.: 19/264,124

(22) Filed: Jul. 9, 2025

Related U.S. Application Data
(60) Provisional application No. 63/668,917, filed on Jul. 9, 2024.

(51) Int. Cl. G09B 5/06; G09B 5/12

(52) U.S. Cl. CPC G09B 5/065; G09B 5/12

(57) ABSTRACT

A system may include a web server to receive an input associated with a first user, where the input includes an assessment question and associates the assessment question with a rubric, where the rubric includes a set of criteria, where each criterion of the set of criteria includes a description and a scale with a set of scale values. The system may further include a media server to receive an audiovisual input associated with a second user. The web server may be further configured to generate an evaluation tool accessible by the first user, where the audiovisual recording is embedded in the evaluation tool, and where the evaluation tool further includes a transcript of the audiovisual recording, an analysis of communication metrics associated with the audiovisual recording, and the rubric. The media server may also enable streaming of the audiovisual recording embedded in the evaluation tool.

### CROSS-REFERENCE TO RELATED APPLICATIONS

This application claims the benefit of, U.S. Provisional Patent Application No. 63/668,917, filed Jul. 9, 2024, and entitled “Asynchronous Oral Assessment,” the contents of which are incorporated by reference herein in their entirety.

### FIELD OF THE DISCLOSURE

This disclosure is generally related to the field of oral assessment and, in particular, to systems and methods for asynchronous oral assessment.

### BACKGROUND

Oral assessments are highly valued for their ability to assess in-depth knowledge, oral communication skills, and their realism in simulating real-world scenarios, such as job interviews and customer interactions. Additionally, the authenticity of responses in oral assessments makes them difficult to fake. However, they have traditionally only been utilized in limited capacities (such as small classroom settings) due to their resource-intensive nature. For example, in a typical setting, oral assessments may occur one-on-one with an instructor or other assessor, which may be impractical for larger classroom settings. Other disadvantages may exist.

### SUMMARY

Disclosed are systems and methods that overcome at least one of the shortcomings described above. The proposed systems and methods are capable of conducting large numbers of oral assessments while reducing resources dedicated to administration and evaluation. The proposed asynchronous oral assessment uses a structured web-based platform to automatically deliver assessment questions to participants. Participants respond to the questions verbally while being recorded by the camera on their computers or mobile devices. Questions can either be predefined by the administrator or dynamically generated by an AI engine based on content previously submitted by the participant. Responses are then made available to administrators for evaluation. The assessment of videos by administrators may be enhanced through automated extraction of quantitative oral communication, knowledge, and credibility metrics (e.g., loudness, speech variability, language complexity, etc.), automated transcript generation, playback speed adjustment, and structured rubrics. These features support both knowledge verification and credibility assessment, enabling broad use in academic, professional, and research settings. The culmination of these components delivers a scalable and versatile assessment platform that supports rigorous evaluation across diverse domains.

In an embodiment, a system for knowledge assessment in an educational or other environment includes at least one processor and memory, where the memory stores instructions that, when executed by the processor, cause the processor to receive an assessment creation input associated with a first user, where the assessment creation input includes at least an assessment question. The instructions further cause the processor to receive association input associated with the first user, where the association input associates the assessment question with a rubric, where the rubric includes a set of criteria, where each criterion of the set of criteria includes a criterion description and a scale that associates a set of scale descriptions with a set of scale values. The instructions also cause the processor to receive an audiovisual input associated with a second user, where the audiovisual input includes an audiovisual recording. The instructions cause the processor to generate an evaluation tool output accessible by the first user, where the evaluation tool output includes an evaluation tool, where the audiovisual recording is embedded in the evaluation tool, and where the evaluation tool includes a transcript of the audiovisual recording, an analysis of communication metrics associated with the audiovisual recording, and the rubric.

In an embodiment, a system for knowledge assessment in an educational or other environment includes a web server configured to receive an assessment creation input associated with a first user and an association input associated with the first user, where the assessment creation input includes an assessment question, and where the association input associates the assessment question with a rubric, where the rubric includes a set of criteria, where each criterion of the set of criteria includes a criterion description and a scale that associates a set of scale descriptions with a set of scale values. The system further includes a media server configured to receive an audiovisual input associated with a second user, where the audiovisual input includes an audiovisual recording. The web server is further configured to generate an evaluation tool output, where the evaluation tool output includes an evaluation tool, accessible by the first user, where the audiovisual recording is embedded in the evaluation tool, and where the evaluation tool further includes a transcript of the audiovisual recording, an analysis of communication metrics associated with the audiovisual recording, and the rubric. The media server also enables streaming of the audiovisual recording embedded in the evaluation tool.

In an embodiment, a method includes receiving an assessment creation input associated with first user, where the assessment creation input includes an assessment question. The method further includes receiving association input associated with the first user, where the association input associates the assessment question with a rubric, where the rubric includes a set of criteria, where each criterion of the set of criteria includes a criterion description and a scale that associates a set of scale descriptions with a set of scale values. The method also includes receiving an audiovisual input associated with a second user, where the audiovisual input includes an audiovisual recording. The method includes generating an evaluation tool output accessible by the first user, where the evaluation tool output includes an evaluation tool, where the audiovisual recording is embedded in the evaluation tool, and where the evaluation tool includes a transcript of the audiovisual recording, an analysis of communication metrics associated with the audiovisual recording, and the rubric.

### BRIEF DESCRIPTION OF THE DRAWINGS

FIG. 1 is a block diagram depicting an embodiment of a system for knowledge assessment in an educational environment.

FIG. 2 depicts an embodiment of an assessment creation input.

FIG. 3 depicts an embodiment of a rubric input.

FIG. 4 depicts an embodiment of an association input.

FIG. 5 depicts an embodiment of access input.

FIG. 6 depicts an embodiment of an assessment output in an initialized state.

FIG. 7 depicts an embodiment of an assessment output in a preparation state.

FIG. 8 depicts an embodiment of an assessment output in a recording state.

FIG. 9 depicts an embodiment of an evaluation tool output.

FIG. 10 depicts an embodiment of a method for knowledge assessment in an environment.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

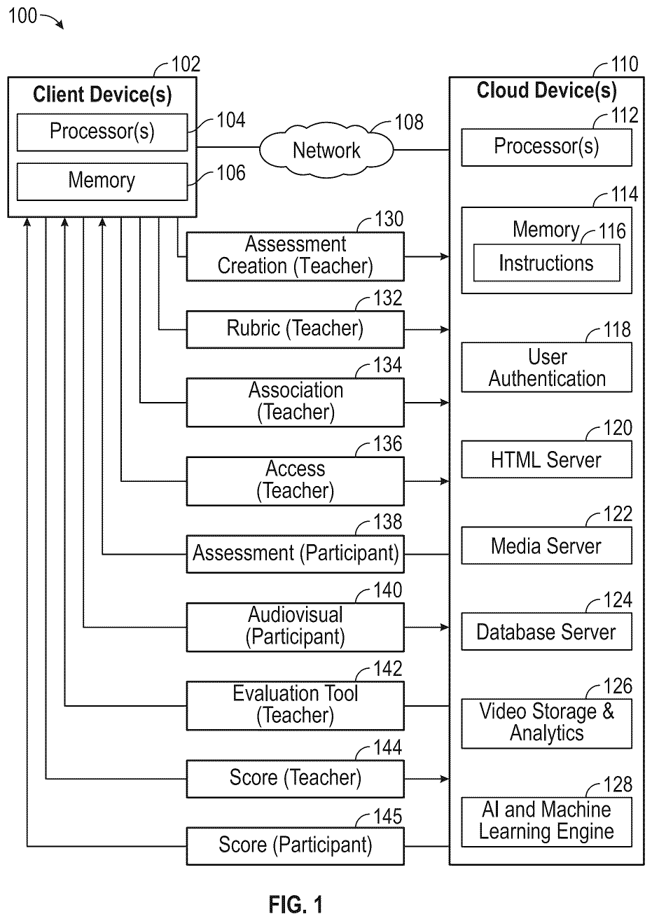

Referring to FIG. 1, a system 100 for asynchronous oral assessment (AOA) may include one or more client devices 102, a network 108, and one or more cloud devices 110. The one or more client devices 102 may include one or more processors 104 and memory 106. As an example, the one or more client devices 102 may correspond to desktops, laptops, tablets, phones, etc. Likewise, the one or more cloud devices 110 may include one or more processors 112 and memory 114.

The one or more processors 104, 112 may include a central processing unit (CPU), a graphical processing unit (GPU), a digital signal processor (DSP), a peripheral interface controller (PIC), another type of microprocessor, and/or combinations thereof. Further, the one or more processors 104, 112 may be implemented as an integrated circuit, field-programmable gate array (FPGA), application-specific integrated circuit (ASIC), combination of logic gate circuitry, another type of digital or analog electrical design components, or combinations thereof. The memory 106, 114 may include memory devices such as random-access memory (RAM), read-only memory (ROM), magnetic disk memory, optical disk memory, flash memory, another type of memory capable of storing data and processor instructions, or the like, or combinations thereof.

The network 108 may include a private or public wide area network (WAN), such as the internet, a local area network (LAN), or a combination thereof. Although not shown, the one or more client devices 102 and the one or more cloud devices 110 may include network modules, each of which may include a network interface controller and may be configured for wired or wireless communication. The network modules may enable communication via the network 108.

The one or more cloud devices 110 may include a user authentication module 118, an html server module, referred to herein as web server 120, a media server module 122, a database server module 124, a video storage and analytics module 126, and an artificial intelligence (AI) and machine learning module 128. The modules 118-128 may be implemented on a single device, or in a distributed structure spanning multiple devices, which may communicate via the network 108, or via other systems.

The AI and machine learning module 128 may implement artificial intelligence algorithms to perform functions described herein. Examples of algorithms that may be used include ant colony optimization, genetic algorithms, evolutionary algorithms, learning classifier systems, self-organizing maps, other types of machine learning classification techniques, or an ensemble model. The AI and machine learning module may be implemented as one or more neural networks, decision trees, nonlinear regression, logistic regression, other types of machine learning classification models, or combinations thereof.

During operation, the one or more cloud devices 110 may receive an assessment creation input 130 associated with a first user (e.g., an administrator) from the user device 102 via the web server 120. The received assessment creation input 130 may include at least one assessment question. The user authentication module 118 may ensure that the assessment creation input 130 is received from the first user via a login mechanism or another authentication protocol.

A rubric input 132 may also be received via the web server 120. The rubric input 132 may include a rubric title, a rubric description, and a set of criteria. For each criterion of the set of criteria, the rubric input 132 may include a criterion description, at least one scale description, and at least one scale value. The one or more processors 112 may generate a rubric, usable by the first user to grade an oral assessment, based on the rubric input 132. The rubric may be stored with a set of rubrics in the database server module 124 and/or generally in the memory 114. Alternatively, in some embodiments, a rubric may be automatically generated based on an artificial intelligence model, such as may be produced using the AI and machine learning module 128.

The first user may also use the one or more client devices 102 to send an association input 134 to the one or more cloud devices 110, which may be received via the web server 120. The association input 134 may associate the assessment question with a rubric. The rubric may be a pre-existing rubric or may be received via the rubric input 132. As explained above, the rubric may include a set of criteria, where each criterion of the set of criteria may include a criterion description and a scale that associates a set of scale descriptions with a set of scale values. Each question on the assessment may be associated with the same rubric or different rubrics.

In addition to creating an assessment and a rubric, and associating the rubric with questions on the assessment, the first user may use the one or more client devices 102 to send an access input 136 to the one or more cloud devices 110 via the web server 120. The access input 136 may be usable to limit access to the assessment (e.g., to participants in a particular course or group).

The one or more cloud devices 110 may generate and provide access to an assessment output 138 to a second user (e.g., a participant) via the web server 120. The user authentication module 118 may restrict access to the assessment output 138 to only those users who have been granted access according to the access input 136. The second user may then take the oral assessment by creating an audiovisual recording using the one or more client devices 102 and may send an audiovisual recording input 140 containing the audiovisual recording to the one or more cloud devices 110. The audiovisual recording may be stored by the media server module 122, enabling the audiovisual recording to be assessed by the first user at a later time, as described herein.

Once the audiovisual input 140 is received, the one or more cloud devices 110 may generate an evaluation tool output 142 and may make it accessible to the first user. To generate the evaluation tool output 142, the video storage and analytics module 126 may generate a transcript of the audiovisual recording, extract linguistic metrics from the transcript, extract paralinguistic metrics (e.g., vocal pitch, loudness, speech quality) from audio associated with the audiovisual recording, extract nonverbal metrics (e.g., facial activity, eye behavior, and hand movements) from video associated with the audiovisual recording, and generate an analysis of the communication metrics based on the transcript, the linguistic metrics, the paralinguistic metrics, the nonverbal metrics, or a combination thereof. An analysis of these metrics may be provided to the first user as part of the evaluation tool output 142.

The audiovisual recording may be embedded in the evaluation tool output 142 and the evaluation tool output 142 may include the transcript of the audiovisual recording, the analysis of communication metrics associated with the audiovisual recording, and the rubric. As stated above, the evaluation tool may be provided after the audiovisual recording has been stored for a period of time. As such, the assessment by the first user may be performed asynchronously relative to the creation of the audiovisual input 140. The evaluation tool is described further herein.

Using the evaluation tool, the first user may provide a score input 144 for use by the one or more cloud devices 110 to create a score output 144 accessible by the second user. The score input 144 may include a selection of scale values for each criterion of the set of criteria and the score output 145 may include a score based at least partially on the selection scale values. In some embodiments, the first user may provide scoring to the second user using another tool or system.

An advantage of the system 100 is that multiple audiovisual inputs may be received from multiple users simultaneously, wherein the multiple audiovisual inputs include multiple audiovisual recordings. Thus, conducting and grading oral assessments may be performed asynchronously and more efficiently as compared to standard methods of oral assessments. Other advantages may exist.

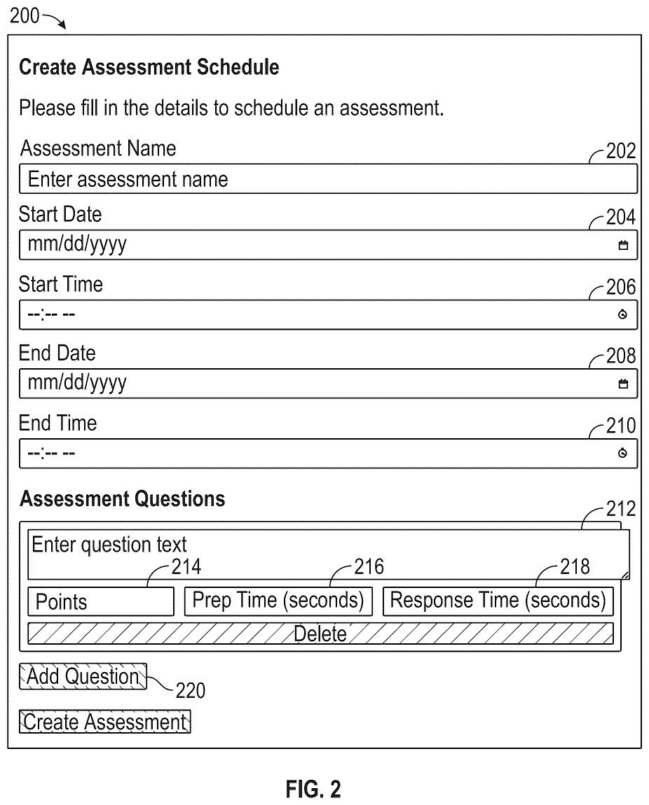

Referring to FIG. 2, an assessment creation input 200 is depicted. The assessment creation input 200 may correspond to the assessment creation input 130 of FIG. 1. As shown in FIG. 2, the assessment creation input 200 may include an assessment name 202, a start date 204, a start time 206, an end date 208, and an end time 210. This may enable the first user (e.g., the administrator) to name and schedule the assessment.

The assessment creation input 200 may further include at least one assessment question 212, a number of points 214 associated with the assessment question 212, a preparation duration 216, and a response duration 218, which will control certain timing aspects for when the second user (e.g., the participant) takes the assessment, as explained further herein.

The assessment creation input 200 may also include an add question button 220. The add question button 220 may enable a user to add additional assessment questions to the assessment creation input 200. The additional assessment questions may include their own additional number of points, additional preparation duration, and additional response duration.

In some embodiments, the questions may be stored as a pool of questions (e.g., at the database server module of FIG. 1). When presented to participants, as described herein, questions may be randomly selected and presented to users from a pool of questions. As an example, an administrator may enter ten assessment questions, using the assessment creation input 200. The administrator may further select an option to randomly select 2 questions per user. This may help reduce question sharing among participants.

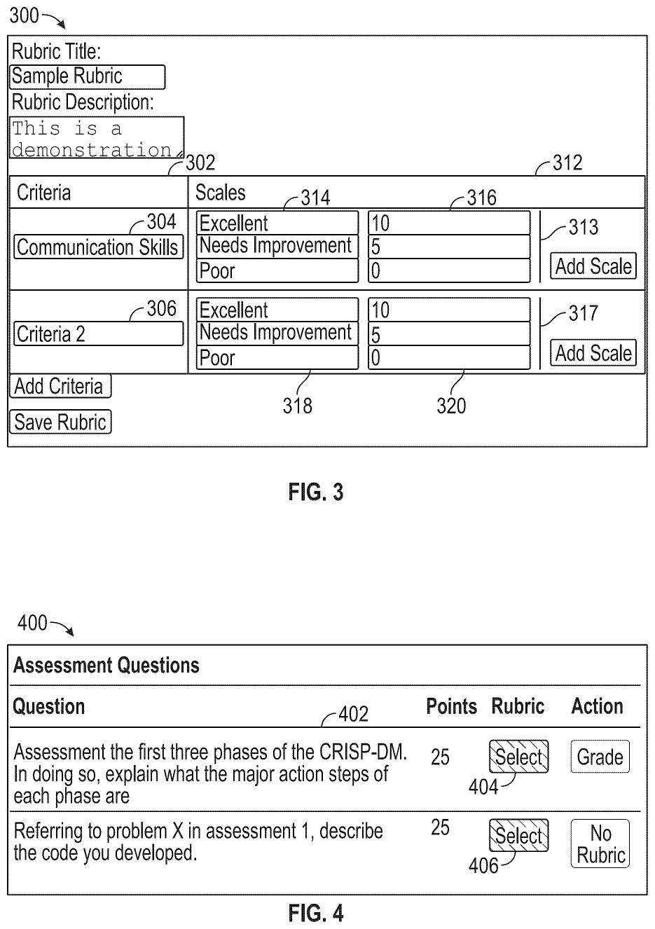

Referring to FIG. 3, a rubric input 300 is depicted. The rubric input 300 may correspond to the rubric input 132 of FIG. 1 and may include a set of criteria 302 and a set of scales 312 associated respectively with the set of criteria 302. The set of criteria 302 may include multiple criteria, such as a first criterion 304 and a second criterion 306. Although FIG. 3 only depicts two criteria, more or fewer may be used, as may be determined and input by the first user (e.g., the administrator). Each criterion 304, 306 may be associated with a respective scale. As an example, the criterion 304 may be associated with the scale 313 and the criterion 306 may be associated with the scale 317. Each of the scales may include a set of scale descriptions and a respective set of scale values. For example, the scale 313 may include a set of scale descriptions 314 each associated respectively with a set of scale values 316. Likewise, the scale 317 may include a set of scale descriptions 318 and a set of associated scale values 320.

Using the rubric input 300, the second user (e.g., the administrator) may create and customize a rubric for the assessment questions. In other embodiments, the rubric may be generated automatically using artificial intelligence, or another automated system.

Referring to FIG. 4, an embodiment of an association input 400 is depicted. The association input 400 may correspond to the association input 134 of FIG. 1 and may include a set of assessment questions 402 and a corresponding set of selectable rubric inputs 404 406 to associate each of the sets of assessment questions with a rubric. In an embodiment, associating the assessment questions 402 with corresponding rubrics may include selecting the rubrics from a set of rubrics stored in memory.

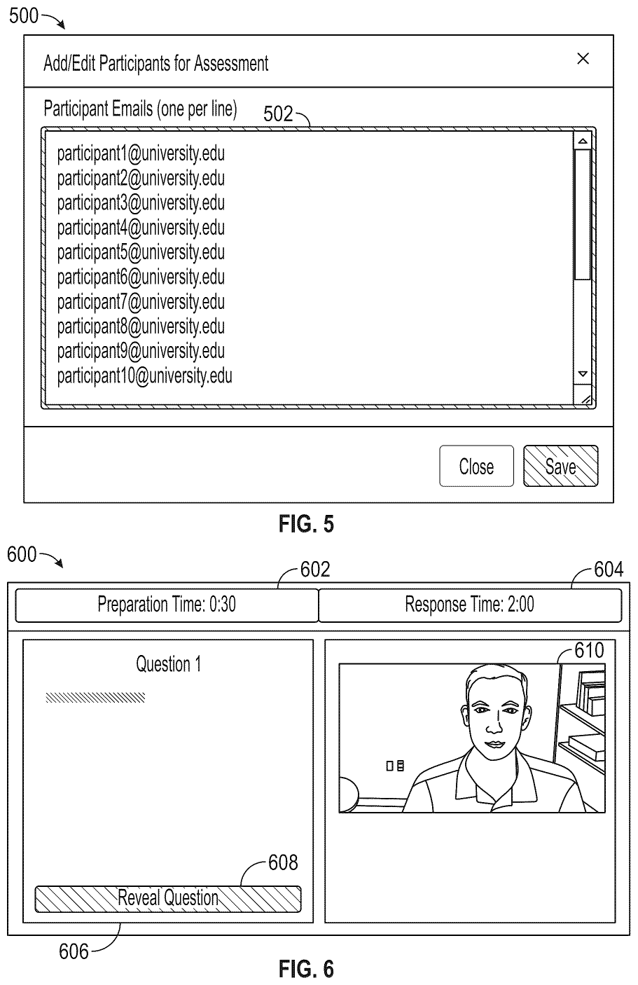

Referring to FIG. 5, an embodiment of an access input 500 is depicted. The access input may correspond to the access input 136 of FIG. 1, which may be received from the first user (e.g., the administrator). The access input 500 may include a set of user identities 502 which may be added by the first user. This may enable the first user to restrict access of created assessment, for example the assessment output 138 of FIG. 1, to users whose identities are in the set of user identities 502. In this way, the assessment may be limited to a set of users (e.g., participants) within a particular course, set of courses, major program, etc.

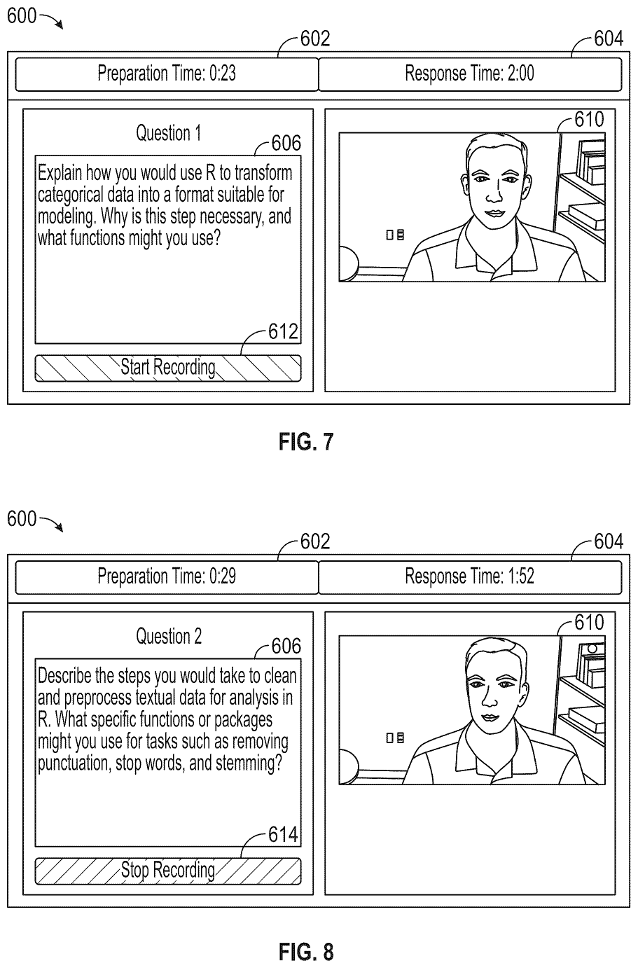

Referring to FIGS. 6, 7 and 8, an embodiment of an assessment output 600 is depicted, which may correspond to the assessment output 138. The assessment output 600 may include a reveal question button 608, a preparation duration 602, a start recording button 612 (depicted in FIG. 7), a response duration 604, a video feed 610, and a stop recording button 614 (depicted in FIG. 8).

As shown in FIG. 6, an assessment question 606 may be initially blurred until a user presses the reveal question button 608. Once the reveal question button 608 is pressed, the assessment question 606 may be made visible and the preparation duration 602 begins to count down, as shown in FIG. 7. This may provide the user time to prepare to answer the assessment question 606. The start recording button 612 may also become visible. When the preparation duration 602 has elapsed or when the user presses the start recording button 612, recording of an audiovisual recording may begin. The video feed 610 enables the user to view themselves while answering the assessment question 606. The stop recording button 614 may become visible to enable the user to stop the recording, as shown in FIG. 8. The response duration 604 may begin to count down. Once the stop recording button 614 is pressed or when the response duration 604 elapses, the session may end and the audiovisual recording, which may correspond to the audio visual input 140 of FIG. 1, may be forwarded to the one or more cloud devices 110 for processing, as described herein.

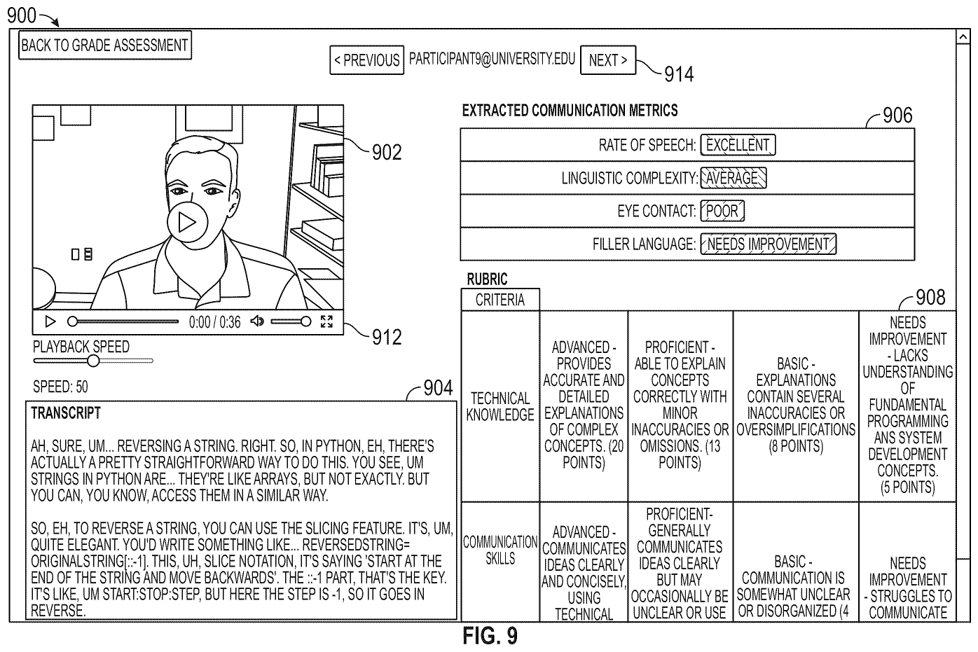

Referring to FIG. 9, an embodiment of an evaluation tool 900 is depicted. The evaluation tool 900 may include an embedded audiovisual recording 902, a transcript 904 of the audiovisual recording 902, an analysis of communication metrics 906 associated with the audiovisual recording 902, and a rubric 908. The audiovisual recording 902 may correspond to the evaluation tool 142 of FIG. 1. The audiovisual recording 902 may correspond to the audiovisual input 140 of FIG. 1, received from the second user (e.g., the participant) in response to a question presented as part of the assessment output 138.

As shown in FIG. 9, the evaluation tool 900 may include controls 912 to enable a user to pause, skip through, adjust the volume, and adjust the playback speed of the embedded audio visual recording 902. Additional controls may exist.

The transcript 904 may correspond to the transcript generated by the video storage and analytics module 126 of FIG. 1. Likewise, the analysis of communications metrics 906 may correspond to the analysis performed video storage and analytics module 126. As shown in FIG. 9, the analysis may include an assessment of a rate of speech, linguistic complexity, eye contact, and filler language.

The rubric 908 may correspond to the rubric input 132 of FIG. 1 and may be incorporated into the evaluation tool 900 to enable the first user (e.g., the administrator) to evaluate the embedded audio visual recording 902 in a systematic way. As may be appreciated by the description herein, the rubric 908 may be customized depending on a particular question and the first user may selectively associate a customized rubric with the question. A set of selection buttons 914 may enable the first user to evaluate additional audiovisual recordings submitted by additional users.

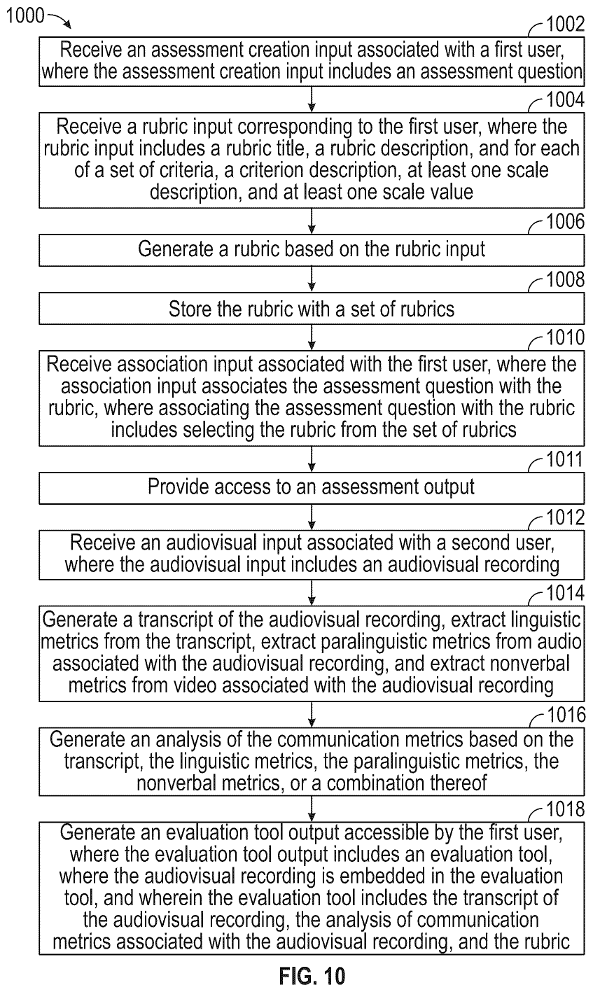

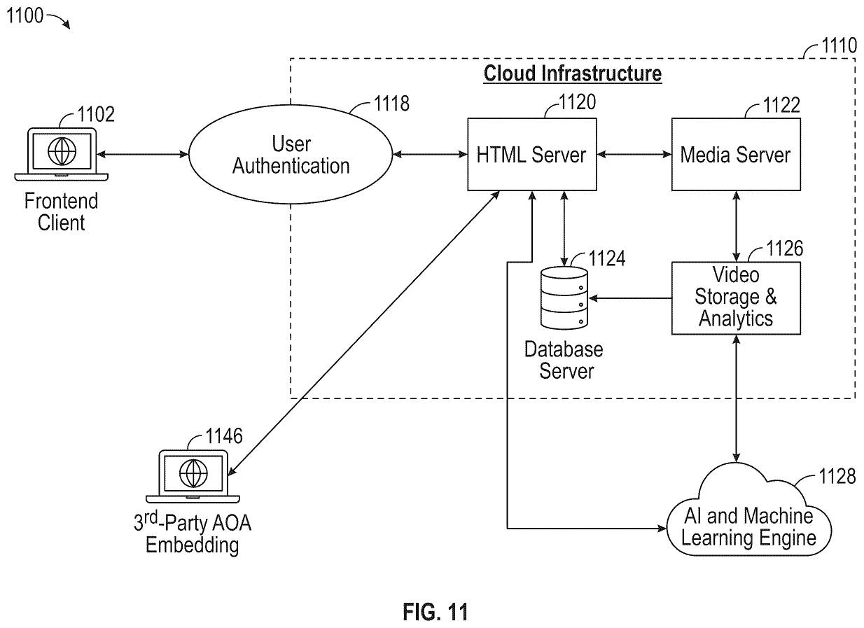

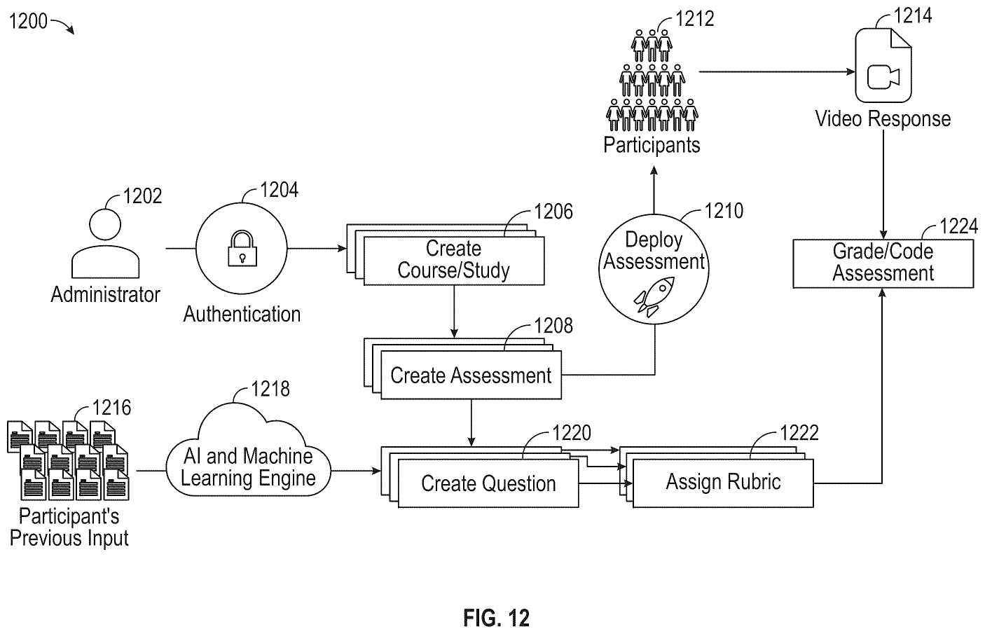

Referring to FIG. 10, an embodiment of a method 1000 for knowledge assessment in an environment is depicted. In some embodiments, the method 1000 may be performed by the system 100 of FIG. 1 and may be represented in the instructions 116 of FIG. 1.

The method 1000 may include receiving an assessment creation input associated with a first user, where the assessment creation input includes an assessment question, at 1002. For example, the assessment creation input 130 may be received by the one or more cloud devices 110 from the one or more client devices 102.

The method 1000 may further include receiving a rubric input corresponding to the first user, where the rubric input includes a rubric title, a rubric description, and for each of a set of criteria, a criterion description, at least one scale description, and at least one scale value, at 1004 For example the rubric input 132 may be received at the one or more cloud devices 110.

The method 1000 may also include generating a rubric based on the rubric input, at 1006. The rubric may include the set of criteria, where each criterion of the set of criteria includes the criterion description and a scale that associates a set of scale descriptions with a set of scale values.

The method 1000 may include storing the rubric with a set of rubrics, at 1008. For example, the rubric may be stored at the one or more cloud devices 110 within the memory 114 and/or the database server module 124.

The method 1000 may further include receiving an association input associated with the first user, where the association input associates the assessment question with the rubric, where associating the assessment question with the rubric includes selecting the rubric from the set of rubrics, at 1010. For example, the association input 134 may be received at the one or more cloud devices 110. As explained herein, a rubric may be created based on the rubric input and the rubric may include the set of criteria, where each criterion of the set of criteria includes the criterion description and a scale that associates a set of scale descriptions with a set of scale values.

The method 1000 may further include providing access to an assessment output, at 1011. For example, a second user can use a different device of the one or more client devices 102 to access the exam output 138 of FIG. 1.

The method 1000 may also include receiving an audiovisual input associated with the second user, where the audiovisual input includes an audiovisual recording, at 1012. For example, the one or more cloud devices 110 may receive the audiovisual input 140.

The method 1000 may include generating a transcript of the audiovisual recording, extracting linguistic metrics from the transcript, extracting paralinguistic metrics from audio associated with the audiovisual recording, and extracting nonverbal metrics from video associated with the audiovisual recording, at 1014.

The method may further include generating an analysis of the communication metrics based on the transcript, the linguistic metrics, the paralinguistic metrics, the nonverbal metrics, or a combination thereof, at 1016. For example, the video storage and analytics module 126 may generate the analysis.

The method may also include generating an evaluation tool output accessible by the first user, where the evaluation tool output includes an evaluation tool, where the audiovisual recording is embedded in the evaluation tool, and wherein the evaluation tool includes the transcript of the audiovisual recording, the analysis of communication metrics associated with the audiovisual recording, and the rubric, at 1018. The first user may use the evaluation tool output to evaluate the second user's performance in responding to the questions in the assessment.

### Example Use Case 1—Scientific Data Collection

In addition to its use in educational settings, the AOA platform can be adapted for scientific and research-oriented data collection. Researchers often rely on online surveys or experimental platforms to gather participant responses. However, these tools are increasingly vulnerable to manipulation or low-effort responses, particularly when relying solely on text input.

AOA helps address this challenge by enabling researchers to collect verbal responses via video, preserving the authenticity and spontaneity of participant input. Researchers can embed AOA directly into their existing survey tools, such as Qualtrics, REDCap, or custom web-based forms, using simple integration methods like iframes. This allows a seamless experience where a participant completes a survey and is then prompted to record a short verbal response to a specific question within the same interface.

For example, after completing a Likert-scale section of a survey, a participant might be asked, “Can you explain why you rated that item the way you did?” The AOA component can then activate, record the response using the participant's webcam and microphone, and store the data securely for asynchronous analysis.

Once captured, these responses can be evaluated manually by researchers or automatically processed using AOA's built-in tools to extract linguistic, vocal, and behavioral indicators, such as speech clarity, emotional tone, or cognitive effort. This opens new possibilities for credibility assessment, response validation, and rich qualitative analysis that would be difficult or impossible with written answers alone.

This use case expands the AOA system beyond the classroom, making it a powerful tool for behavioral science, psychology, communication research, and human-computer interaction studies.

Referring to FIG. 11, an AOA system 1100 may include one or more client devices 1102, which may correspond to the one or more client devices 102 of FIG. 1 and one or more cloud devices 1110, which may correspond to the one or more cloud devices 110. The one or more cloud devices 1110 may include a user authentication module 1118, an html server module 1120, a media server module 1122, a database server module 1124, a video storage and analytics module 1126, and an AI and machine learning module 1128, which may correspond respectively to the user authentication module 118, the html server module 120, the media server module 122, the database server module 124, the video storage and analytics module 126, and the AI and machine learning module 128 of FIG. 1.

During operation, a study may be designed and questions may be defined as described herein. In this application, verbal response prompts (questions) may be created by the researcher or automatically generated by previous inputs (see Example Use Case 2), similar to survey or interview items. The questions may be open-ended opinion questions, justification or reasoning prompts, or narrative or recall questions. Each question may be associated with a coding rubric for later analysis (e.g., thematic analysis, sentiment coding, or communication style coding). The creation and association of the rubric may be performed as described herein. For example, a researcher may use the AOA system 1100 to input questions, assign rubrics or coding schemes (either manually or using predefined templates), and set parameters like preparation time and response time.

Once configured, an AOA verbal response module may be embedded into a third-party survey or research instrument 1146, as shown in FIG. 11. Examples of existing survey or research instruments include Qualtrics, REDCap, SurveyMonkey, or Custom research portals. Embedding is typically achieved using HTML iframe integration, allowing an AOA video question module (e.g., the assessment 138 of FIG. 1) to appear seamlessly within a larger survey flow. AOA modules including inputs and/or outputs may also be deployed as a standalone platform. As an example usage, after completing a multiple-choice section in Qualtrics, the participant may be presented a question like “Please explain your answer in your own words,” followed by an embedded AOA video recorder. A preparation timer may be shown and the participant may record their verbal response directly within the embedded module. The response may be captured asynchronously using browser-based technologies (e.g., WebRTC), and the video file may be securely stored as described herein, along with data like a participant identifier or a session token, a question identifier, and/or time metadata. Once collected, verbal responses are stored in a secure database (e.g., the database server 1124). Researchers may manually code the responses using built-in evaluation tools and custom rubrics, as described herein. They may also export video or transcript data for external analysis (e.g., NVivo, MAXQDA). They may further use automated linguistic or paralinguistic feature extraction to generate quantifiable insights (e.g., use of hedging, pitch variability, sentiment markers).

In some embodiments, the platform can optionally generate summary metrics per participant (e.g., average confidence score, speaking duration), flagged responses (e.g., low-quality audio, extremely short responses), and/or aggregated datasets for statistical analysis (e.g., coded rubric scores exported as CSV).

### Example Use Case 2—Authorship and Credibility Verification

Another powerful use case for the AOA platform is in authorship and response verification, especially in educational or professional settings where it's important to confirm that an individual actually created a written submission themselves. However, this is also important in scientific settings where responses to previous questions may need to be validated.

In this approach, AOA is paired with a Generative AI platform to create customized, individualized oral questions based on a participant's prior written work or input. For example, if a student submits an essay, the AI system can analyze the text and generate targeted follow-up questions such as:

“In your paper, you argued that X was the primary cause of Y. Can you explain how you arrived at that conclusion in your own words?”

These questions are then delivered to the participants through the AOA platform, where their verbal responses are recorded on video. The process provides a time-limited, unscripted environment that makes it significantly more difficult to fabricate answers or rely on AI-generated content in real time.

This allows educators, researchers, or verification personnel to assess whether the person truly understands the content they submitted. The recorded responses can be reviewed for alignment with the original submission and/or evaluated using AOA's built-in linguistic and behavioral analysis tools, including speech fluency, confidence indicators, and expressive behavior, offering an added layer of verification.

This capability can help address rising concerns about ghostwriting, plagiarism, and the misuse of generative AI tools in education and publishing. It also has potential applications in areas such as hiring, legal declarations, and grant proposal validation, anywhere where trust in authorship and intellectual ownership is critical.

Referring to FIG. 12, a method 1200 is depicted. The method 1200 may include receiving participants' previous input, at 1216. For example, the system (e.g., the system 100 or the system 1100) receives a written submission from the participant, at 1216, which can take several forms, such as a direct text entry via an input field (e.g., an essay typed into a form), an uploaded file (e.g., PDF, DOCX, or TXT), and/or a pasted excerpt from another digital source. The submitted content may be linked to the participant's profile for downstream processing.

Once the written input is received, the system may process the text and extract key claims, arguments, or reasoning patterns using an AI and Machine Learning Engine, at 1218. For example, the system may use an external or internal Generative AI service (e.g., via API integration) to process the text and extract key claims, arguments, or reasoning patterns. The AI engine may then formulate individualized, open-ended oral questions designed to probe the participant's understanding of their own work, at 1220.

As an example, in a submission, a participate may indicate, “In my analysis, I found that remote work improves productivity due to fewer distractions.” Based on that statement, a question that may be generated could be “Can you explain how you measured productivity in your analysis of remote work?”

The AI-generated questions may be linked to the participant and stored within the system (e.g., at the database server 124, 1124). Each participant may receive a unique question set tailored to their own submission. These questions may not be reused across users, ensuring personalization and reducing the chance of answer sharing or memorization.

The method of delivering the questions to participant 1212 may be as described previously herein. For example, an administrator 1202, after authentication, at 1204, may create a course or study or other like category, at 1206, and create an assessment, at 1208, which may be deployed, at 1210, to the participants 1212. A rubric may also be assigned to each question, at 1222, as previously described herein.

When the participant 1212 accesses the AOA platform (either through a standalone link or embedded in an LMS or survey tool), the system may authenticate the user and retrieve the individualized questions. The questions may be presented one at a time, optionally with a preparation timer, after which the participant may be recorded responding to the question via webcam and microphone.

As the participant answers each question, audio and video streams may be recorded via the browser (e.g., using WebRTC). The system may capture and stores the media (e.g., at the media server module 122, 1122 of FIGS. 1 and 11) in association with the question and participant identification. Optional metadata such as timestamps, speech rate, or filler words may also be extracted at this stage.

Recorded responses may be made available for human evaluation or automated analysis, at 1224, allowing instructors or reviewers to compare the participant's verbal response to their original submission, assess credibility, fluency, and understanding, and use AI tools to flag inconsistencies, low-confidence delivery, or indicators of inauthenticity.

As explained herein, the disclosed methods and systems may help facilitate oral assessments, by enabling asynchronous evaluation and providing a streamlined process for using a rubric to evaluation multiple responses. Although various embodiments have been shown and described, the present disclosure is not so limited and will be understood to include all such modifications and variations as would be apparent to one skilled in the art.

What is claimed is:

1. A system comprising at least one processor and memory, wherein the memory stores instructions that, when executed by the processor, cause the processor to:
receive association input associated with a first user, wherein the association input associates an assessment question with a rubric, wherein the rubric includes a set of criteria, wherein each criterion of the set of criteria includes a criterion description and a scale that associates a set of scale descriptions with a set of scale values;
receive an audiovisual input associated with a second user, wherein the audiovisual input includes an audiovisual recording;
generate an evaluation tool output accessible by the first user, wherein the evaluation tool output includes an evaluation tool, wherein the audiovisual recording is embedded in the evaluation tool, and wherein the evaluation tool includes a transcript of the audiovisual recording, an analysis of communication metrics associated with the audiovisual recording, and the rubric.

2. The system of claim 1, wherein the instructions further cause the processor to receive an assessment creation input associated with the first user, wherein the assessment creation input includes the assessment question.

3. The system of claim 2, wherein the assessment creation input further includes an assessment name, a start date, a start time, an end date, an end time, a number of points associated with the assessment question, a preparation duration associated with the assessment question, a response duration associated with the assessment question, or a combination thereof.

4. The system of claim 3, wherein the assessment creation input further includes at least one additional assessment question, an additional number of points associated with the at least one additional assessment question, an additional preparation duration associated with the at least one additional assessment question, and an additional response duration associated with the at least one additional assessment question.

5. The system of claim 1, wherein the instructions further cause the processor to generate an assessment question based on stored writings associated with a second user using an artificial intelligence model.

6. The system of claim 1, wherein the instructions further cause the processor to:
generate the transcript of the audiovisual recording;
extract linguistic metrics from the transcript;
extract paralinguistic metrics from audio associated with the audiovisual recording;
generate the analysis of the communication metrics based on the transcript, the linguistic metrics, the paralinguistic metrics, or a combination thereof.

7. The system of claim 6, wherein the instructions further cause the processor to:
extract nonverbal metrics from video associated with the audiovisual recording; and
generate the analysis of the communication metrics based further on the nonverbal metrics.

8. The system of claim 1, wherein the instructions further cause the processor to:
receive a rubric input corresponding to the first user, wherein the rubric input includes a rubric title, a rubric description, and for each of the set of criteria, the criterion description, at least one scale description, and at least one scale value;
generate the rubric based on the rubric input; and
store the rubric with a set of rubrics, wherein associating the assessment question with the rubric includes selecting the rubric from the set of rubrics.

9. The system of claim 1, wherein the rubric is automatically generated by an artificial intelligence model.

10. The system of claim 1, wherein the instructions further cause the processor to generate an assessment output accessible by the second user, the assessment output including a reveal question button, a preparation timer, a start recording button, a response timer, a video feed, a stop recording button, or any combination thereof.

11. The system of claim 10, wherein the assessment output is incorporated into a scientific data collection interface module.

12. The system of claim 10, wherein the instructions further cause the processor to receive access input corresponding to the first user wherein the access input includes a set of user identities, wherein access to the assessment output is limited to users whose identities are in the set of user identities.

13. The system of claim 1, wherein the instructions further cause the processor to:
receive a score input corresponding to the first user, wherein the score input includes a selection of scale values for each criterion of the set of criteria; and
generate a score output accessible by the second user, wherein the score output includes a score based at least partially on the selection scale values.

14. The system of claim 1, wherein the receiving the audiovisual input and generating the evaluation tool output are performed asynchronously, wherein multiple additional inputs may be received from multiple additional users simultaneously with the second input, wherein the multiple additional inputs include multiple additional audiovisual recordings.

15. A system comprising:
a web server configured to receive an association input associated with a first user, wherein the association input associates an assessment question with a rubric, wherein the rubric includes a set of criteria, wherein each criterion of the set of criteria includes a criterion description and a scale that associates a set of scale descriptions with a set of scale values;
a media server configured to receive an audiovisual input associated with a second user, wherein the audiovisual input includes an audiovisual recording,
wherein the web server is further configured to generate an evaluation tool output, wherein the evaluation tool output includes an evaluation tool, accessible by the first user, wherein the audiovisual recording is embedded in the evaluation tool, and wherein the evaluation tool further includes a transcript of the audiovisual recording, an analysis of communication metrics associated with the audiovisual recording, and the rubric, and
wherein the media server enables streaming of the audiovisual recording embedded in the evaluation tool.

16. The system of claim 15, wherein the web server is configured to receive assessment creation input associated with the first user, wherein the assessment creation input includes the assessment question.

17. The system of claim 15, further comprising an artificial intelligence and machine learning engine configured to be used to generate the assessment question based on stored writings associated with the second user using an artificial intelligence model.

18. The system of claim 15, wherein the web server is configured to generate an assessment output, and wherein the assessment output is incorporated into a scientific data collection interface module.

19. The system of claim 15, further comprising a video storage and analytics module configured to:
perform at least one of the following:
generate the transcript of the audiovisual recording;
extract linguistic metrics from the transcript;
extract paralinguistic metrics from audio associated with the audiovisual recording; or
extract nonverbal metrics from video associated with the audiovisual recording; and
generate the analysis of the communication metrics based on the transcript, the linguistic metrics, the paralinguistic metrics, the nonverbal metrics, or any combination thereof.

20. A method comprising:
receiving an assessment creation input associated with first user, wherein the assessment creation input includes an assessment question;
receiving association input associated with the first user, wherein the association input associates the assessment question with a rubric, wherein the rubric includes a set of criteria, wherein each criterion of the set of criteria includes a criterion description and a scale that associates a set of scale descriptions with a set of scale values;
receiving an audiovisual input associated with a second user, wherein the audiovisual input includes an audiovisual recording;
generating an evaluation tool output accessible by the first user, wherein the evaluation tool output includes an evaluation tool, wherein the audiovisual recording is embedded in the evaluation tool, and wherein the evaluation tool includes a transcript of the audiovisual recording, an analysis of communication metrics associated with the audiovisual recording, and the rubric.
